(19) United States
(12) Patent Application Publication
(10) Pub. No.: US 2015/0043522 A1
(43) Pub. Date: Feb. 12, 2015

(54) ENHANCED MU-MIMO NETWORK ASSISTED INTERFERENCE SUPPRESSION

(71) Applicant: Broadcom Corporation, Irvine, CA (US)

(72) Inventors: Amin MOBASHER, Menlo Park, CA (US); Louay JALLOUL, San Jose, CA (US)

(73) Assignee: BROADCOM CORPORATION, Irvine, CA (US)

(21) Appl. No.: 14/454,286

(22) Filed: Aug. 7, 2014

Related U.S. Application Data
(60) Provisional application No. 61/863,316, filed on Aug. 7, 2013.

(51) Int. Cl. H04W 72/08; H04W 72/02; H04B 7/04

(52) U.S. Cl. CPC H04W 72/082; H04B 7/0452; H04B 7/0456; H04W 72/02
USPC 370/330

(57) ABSTRACT

An interference suppression (IS) time/frequency zone for improved interference suppression is provided. The IS time/frequency zone can be scheduled and set up using existing signaling of the Almost Blank Subframe (ABS) framework. This includes using the existing signaling of the ABS framework to schedule the IS time/frequency zone, coordinate transmission parameters among base stations for the IS time/frequency zone, and signal the IS time/frequency zone to the UT. In another aspect, interfering base stations align respective reference signals during the IS time/frequency zone, which allows the UT to measure the channels from its serving base station and/or the interfering base stations(s). With channel state information knowledge at the UT, interference suppression can be achieved.

### CROSS-REFERENCE TO RELATED APPLICATIONS

The present application claims the benefit of U.S. Provisional Application No. 61/863,316, filed Aug. 7, 2013, which is incorporated herein by reference in its entirety.

### BACKGROUND

1. Field of the Invention

The present disclosure relates generally to interference suppression in cellular networks.

2. Background Art

Cellular networks are experiencing a significant increase in traffic demand. This makes interference management significantly important for adequate user experience.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example cellular network environment in which embodiments can be used implemented.

FIG. 2 is an example that illustrates the alignment of serving and interfering reference signals according to an embodiment.

FIG. 3 illustrates a block diagram of an example cellular network environment according to an embodiment.

FIG. 4 illustrates an example receiver according to an embodiment.

FIG. 5 is an example process for facilitating interference suppression according to an embodiment.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

For purposes of this discussion, the term “module” shall be understood to include at least one of software, firmware, and hardware such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

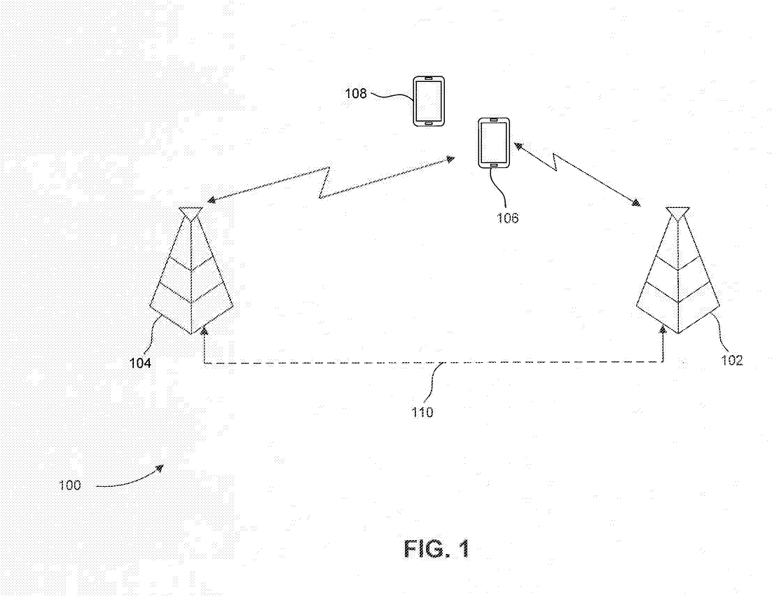

FIG. 1 illustrates an example cellular network environment 100 in which embodiments can implemented. Example cellular network environment 100 is provided for the purpose of illustration only and is not limiting of embodiments. For example, embodiments may be applied to other types of wireless communication networks other than cellular networks.

As shown in FIG. 1, example cellular network environment 100 includes base stations 102 and 104 and user terminals (UTs) 106 and 108. Base stations 102 and 104 can communicate with each other via a backhaul network (e.g., X2 interface) link 110. UTs 106 and 108 can be any wireless device capable of cellular-based communication, including a cellular phone, tablet, laptop, etc. Base stations 102 and 104 can each support a serving cell or sector that has a unique cell ID that identifies it to the UTs.

For the purpose of describing embodiments, it is assumed that UT 106 is in a first cell served by base station 102 and UT 108 is in a second cell served by base station 104. It is farther assumed that base station 102 and base station 104 are within the same geographical area such that signals transmitted from base station 104 to, for example, UT 108 may interfere with signals transmitted from base station 102 to, for example, UT 106, and/or vice versa. Further, base station 102 and base station 104 can be part of a microcell, picocell, femtocell, or small cell network and can be located either outdoor or indoor.

As would be understood by a person of skill in the art based on the teachings herein, embodiments are not limited by the above example scenario. In other embodiments, the interfering base station can be located at the same base station as the serving base station. Also, in another embodiment, different remote radio heads belonging to one or more base stations can be considered as base stations 102 and 104. Further, embodiments can be extended to environments that include a plurality of interfering base stations (located at the same or different base stations) that interfere with the serving base station.

In commonly owned U.S. patent application Ser. No. 13/838,387, filed Mar. 15, 2013, titled “Interference Suppression for Cellular Networks,” which is incorporated herein by reference, a framework for assisting UTs (referred to as UEs in U.S. patent application. Ser. No. 13/838,387) to reduce interference from an interfering base station, without degrading the downlink throughput of the interfering base station is provided. Specifically, the framework enables an interference suppression (IS) time and frequency (time/frequency) zone which can be scheduled by a serving base station (with or without coordination with the interfering base station) and signaled to the UT. The IS time/frequency zone can be scheduled to coincide with a network condition favorable to interference suppression at the UT and thus can be used by the UT to apply interference suppression with positive effect. The network condition favorable to interference suppression at the UT can be created by the serving base station in coordination with the interfering base station by setting (and/or fixing) their respective transmission parameters during the IS time/frequency zone. The serving base station can also opportunistically schedules the IS time/frequency zone for the UT whenever the base station or the UT determines favorable transmission parameters being used or scheduled to be used by the interfering base station. The transmission parameters of the serving and/or interfering base station that may be set include one or more of transmission mode (TM), transmission power level, modulation scheme, coding scheme, pilot timing and/or structure, frame structure, resource allocation mode, and any other parameter that can facilitate interference suppression at the assisted UT. The UT applies interference suppression processing within the IS time/frequency zone, thereby improving receiver performance. Outside the time/frequency zone, the UT may disable interference suppression processing so as not to degrade receiver performance.

In the present disclosure, further embodiments for using the IS time/frequency zone for interference suppression are provided. Specifically, in an embodiment, the IS time/frequency zone can be scheduled and set up using existing signaling of the Almost Blank Subframe (ABS) framework (described in LTE Release-10 and LTE Release-11, which are incorporated herein by reference in their entireties). This includes using the existing signaling of the ABS framework to enable, disable, and schedule the IS time/frequency zone, coordinate transmission parameters for the IS time/frequency zone, and signal the IS time/frequency zone to the UT. This makes the IS time/frequency zone framework a logical extension of ABS for future LTE standards.

In another aspect, reference signals of the serving base station and the interfering base station(s) can be aligned during the IS time/frequency zone to allow the UT to measure the channels from the serving base station and/or the interfering base stations(s). Enhanced interference suppression at a serving base station operating in a multi-user MIMO (MU-MIMO) mode can be achieved as a result of estimating the channels from the serving base station and the interfering base station(s) as further described below. The UTs can be informed that their serving base stations are operating or about to operate in a MU-MIMO mode to allow the UTs to participate in the enhanced interference suppression scheme.

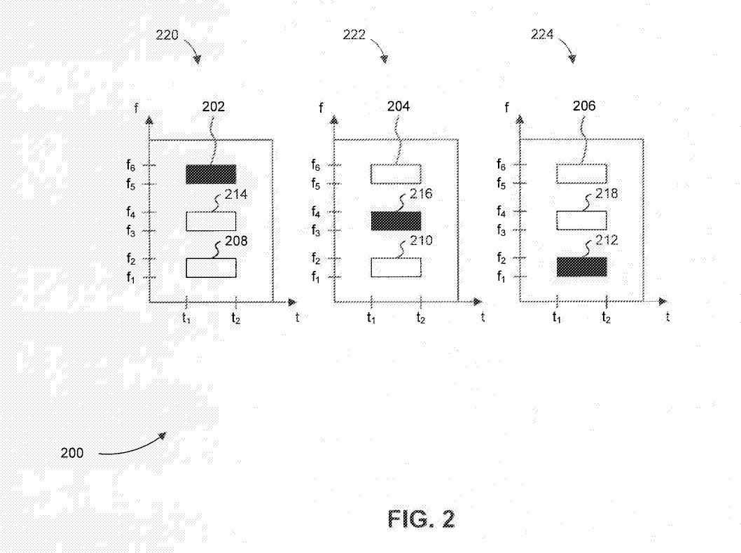

FIG. 2 is an example 200 that illustrates the alignment of serving and interfering reference signals during an IS time/frequency zone according to an embodiment. Specifically, example 200 illustrates example downlink transmission schedules 220, 222, and 224 of a serving base station and two interfering base stations, respectively, according to an embodiment. In an embodiment, the two interfering base stations represent the two main interferers to a UT served by the serving base station, and the interference floor other interfering base stations to this UT is sufficiently low that it can be treated as noise. As would be understood by a person of skill in the art based on the teachings herein embodiments are not limited to example 200 and, more specifically, are not limited to only three base stations.

Downlink transmission schedule 220 of the serving base station includes resource elements (REs) 202, 208, and 214. REs 202 are designated for transmitting a first reference signal, and REs 208 and 214 are respectively designated for transmitting second and third reference signals (the second and third reference signals are herein referred to collectively as secondary reference signals, which can include zero power reference signals as further described below).

Downlink transmission schedule 222 of the first one of the two interfering base stations includes REs 204, 216, and 210. REs 216 are designated for transmitting the first reference signal, and REs 204 and 210 are respectively designated for transmitting second and third reference signals (including zero power reference signals).

Downlink transmission schedule 224 of the second, one of the two interfering base stations includes REs 206, 218, and 212. REs 212 are designated for transmitting the first reference signal, and REs 206 and 218 are designated for transmitting the second and third reference signals (including zero power reference signals).

In another embodiment, REs 202 can correspond to all the REs that the serving base station allocates to multiple UTs for one port of the serving base station. As would be understood by a person of skill in the art based on the teachings herein, REs 202 are not limited to being allocated contiguously in time or frequency even though they are depicted as contiguous in FIG. 2. The same applies to all REs allocated for other reference signals for serving and interfering base stations.

As would be understood by a person of skill in the art based on the teachings herein, downlink transmission schedules 220, 222, and 224 respectively represent the resource grid for one antenna port of the serving base station and the two interfering base stations. If the base stations have multiple antenna ports, there would be a resource grid per antenna port, and per resource grid there would be REs allocated for reference signals.

As shown in FIG. 2, the REs designated for transmitting the first reference signal for each of the serving base station and the two interfering base stations is aligned in time and frequency with REs designated for transmitting the secondary reference signals (second and third reference signals) at the other two base stations. For example, REs 202 of the serving base station is aligned in time and frequency with REs 204 and REs 206 of the two interfering base stations. REs 216 of the first one of the two interfering base stations is aligned in time and frequency with REs 214 of the serving base station and REs 218 of the second one of the two interfering base stations. REs 212 of the second one of the two interfering base stations is aligned in time and frequency with REs 208 of the serving base station and REs 210 of the second one of the two interfering base stations.

In an embodiment, the first reference signal corresponds to the non-zero power (NZP) channel state information (CSI) reference signal (RS) (NZP-CSI-RS) and the second and third reference signals (secondary reference signals) correspond to the zero power (ZP) CSI RS (ZP-CSI-RS), which are defined by the LTE standard. In another embodiment the reference signals can be zero-power and non-zero power DeModulating Reference Signals (DMRS) (e.g., first reference is non-zero power DMRS and second and third reference signals are zero power DMRS).

Accordingly, a UT can measure the downlink channel from the serving base station over the time and frequency REs 202 because REs 202 carry a non-zero power reference signal from the serving base station and REs 204 and 206 carry zero power reference signals from the two interfering base stations. The UT can also measure the downlink channel from the first one of the two interfering base stations over the time and frequency REs 214 because REs 216 carries a non-zero power reference signal from the first one of the two interfering base stations and REs 214 and 218 carry zero power reference signals. Finally, the UT can measure the downlink channel from the second of the two interfering base stations over the time and frequency REs 208 because REs 212 carries a non-zero per reference signal from the second one of the two, interfering base stations and REs 208 and 210 carry zero power reference signals. As would be understood by a person of skill in the art, any UT served by the serving base station or by one of the two interfering base stations can rely on the alignment of the first and secondary reference signals as described above to measure the downlink channels from the three base stations.

In an embodiment, the alignment of the first and second reference signals, as described above, is coordinated among the base stations ahead of the scheduling of an IS time/frequency zone and signaled by each base station to its served UTs. In an embodiment, the alignment is signaled to the UTs along with the signaling of the scheduling of the IS time/frequency zone and any set transmission parameters during the IS time/frequency zone. As would be understood by a person of skill in the art based on the teachings herein, the alignment of the reference signals could be independent of the scheduling of the IS time/frequency zone. In a further embodiment, the alignment is signaled to the UTs along with an indication that the UTs will be transmitted to in the downlink direction from their serving base station in a MU-MIMO mode.

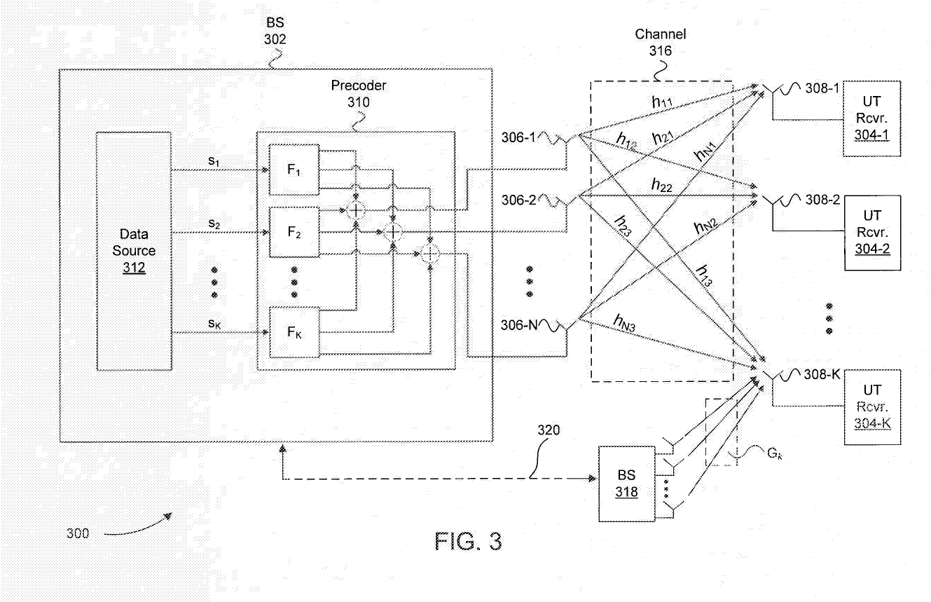

Enhanced interference suppression at a serving base station operating in a MU-MIMO mode can be achieved as a result of estimating the channels from the serving base station and the interfering base station(s). In general, when multiple UTs are each served one or more independent data streams by a serving base station over the same time-frequency interval, the system is said to be performing MU-MIMO. A limitation on the number of independent data streams that can be transmitted over the same time-frequency interval and/or the data throughput of the independent data streams results from interference between the independent data streams or what is referred to as inter-user interference including inter-user interference from data streams originating from interfering base stations in nearby or adjacent cells or sectors. MU-MIMO and inter-user interference are described further below with respect to FIG. 3.

In FIG. 3, a block diagram of an exemplary cellular network environment 300 that includes a base station 302 and multiple UT receivers 304-1 through 304-K is illustrated in accordance with embodiments of the present disclosure. Base station 302 can be, for example, base station 102 in FIG. 1, and UT receivers 304-1 through 304-K can be receivers served by base station 102. In the exemplary embodiment of FIG. 3, base station 302 includes N transmit antennas 306-1 through 306-N, and UT receivers 304-1 through 304-K each include a respective one of receive antennas 308-1 through 308-K.

In operation of cellular network environment 300, base station 302 is configured to transmit an independent data stream to each UT receiver 304-1 through 304-K over the same time-frequency interval in accordance with a MU-MIMO mode. Base station 302 specifically uses a precoder 310 to precode the independent data streams before they are transmitted to reduce interference between them, in FIG. 3, the independent data streams are labeled s through s_{K} and are provided to precoder 310 by a data source 312. Several different precoding techniques can be used, including matched-filter (MF) precoding, zero-forcing (ZF) precoding, minimum-mean square error (MMSE) precoding, and, with some modifications to precoder 310, non-linear precoding techniques such as vector perturbation. The precoded signal output by precoder 310 can be written as:

x=Σ_{i=1 to K}Fᵢsᵢ, (1)

where sᵢ is a data symbol for the i-th UT receiver, and Fᵢ is a N×1 precoding vector for the i-th UT receiver.

Based on the precoded signal x being appropriately fed to and transmitted by the N transmit antennas 306-1 through 306-N, the symbol received by the k-th UT receiver can be written as

$$\begin{matrix}{y}_{k} = {H}_{k} x + {n}_{k} , \\ = {H}_{k} {\sum }_{i = 1 to K} {F}_{i} {s}_{i} + {n}_{k} ,\end{matrix} \qquad ( 2 )$$

where nₖ is a vector representing noise and Hₖ is a M×N channel matrix of the k-th UT receiver. Each entry in Hₖ corresponds to a respective sub-channel of channel 316) between a respective transmit antenna at the base station and the receive antenna at the k-th UT receiver. The number of columns N in Hₖ is equal to the number of transmit antennas used at base station 302. To provide an example, the channel matrix H₁ for UT receiver 204-1 is given by the vector [h₁₁h₂₁ . . . h_{N1}].

The symbol yₖ received by the k-th UT receiver generally includes inter-user interference from the symbols intended for the other UTs. This component of inter-user interference can be written as follows:

HₖΣ_{i=1 to K}^{i≈k}Fᵢsᵢ. (3)

To suppress the inter-user interference, the precoding vectors Fᵢ can be, for example, selected such that the component of interference given by Eq. (3) is minimized or reduced below some threshold for each UT.

Part of the noise vector nₖ often includes interference from an interfering base station 318 in an adjacent or nearby cell also operating in a MU-MIMO mode. Instead of lumping this interference in with the noise vector nₖ, it can be written as a separate term. For example, the symbol received by the k-th UT receiver can be rewritten as:

$$\begin{matrix}{y}_{k} = {H}_{k} x + {G}_{k} Pz + {n}_{k} , \\ = {H}_{k} {\sum }_{i = 1 to K} {F}_{i} {s}_{i} + {G}_{k} Pz + {n}_{k} ,\end{matrix} \qquad ( 4 )$$

where Gₖ is the channel between the k-th UT and interfering base station 318, P is a precoder vector used by interfering base station 318, and z is a data stream precoded with the precoder vector P and transmitted by interfering base station 318.

Assuming that the k-th UT measures the channel between the k-th UT and serving base station 302 and measures the channel between the k-th UT and interfering base station 318 using reference signals of the serving base station and interfering base station aligned during, for example, an IS time/frequency zone as explained above, the k-th UT can determine a precoder vector P for interfering base station 318 that suppresses or minimizes interference from interfering base station 318 and can also determine a precoder vector Fₖ for the serving base station 302 that enhances the signal strength of the data stream sₖ at the UT. For example, the precoder vector P can be determined such that GₖP is minimized or reduced below some threshold. In one embodiment, the determined precoder vectors are selected from, one or more codebooks and each selected precoder vector corresponds to a respective precoding matrix index (PMI) in the one or more codebooks. Once determined, the k-th UT can feedback the determined precoder vectors or PMI indices to its serving base station 302.

UTs served by interfering base station 318 can perform a similar process as the k-th UT to determine a precoder vector for base station 302 (which would be an interfering base station from the vantage point of the UTs served by interfering base station 318) that minimizes or reduces interference from base station 302 and can determine a precoder vector for interfering base station 318 that enhances the signal strength of the data stream sent to the UT from interfering base station 318. In one embodiment, the determined precoder vectors are selected from one or more codebooks and each selected precoder vector corresponds to a respective precoding matrix index (PMI) in the one or more codebooks. Once determined, the UTs served by interfering base station 318 can feedback the determined precoder vectors or PMI indices to interfering base station 318.

Base station 302 can subsequently coordinate with interfering base station 318 to pair a UT served by base station 302 with a UT served by base station 318 that each fed back the same or similar precoder vectors or PMI indices for each base station. The paired UTs can then be scheduled to receive downlink transmissions from their respective base stations, operating in a MU-MIMO mode, during the same time-frequency interval using the fed back precoder vectors or precoder vectors corresponding to the fed back PMI indices to reduce or minimize interference. To perform this coordination, base station 302 and base station 318 may communicate via a backhaul network (e.g., X2 interface) link 320.

In another embodiment, the k-th UT served by base station 302 can further determine a precoder vector P for interfering base station 318 that increases or maximizes interference from the interfering base station. The k-th UT can then feedback his precoder vector, or corresponding PMI for the precoder vector, to serving base station 302 so that serving base station 302 can coordinate with interfering base station 318 to prevent a UT served by interfering base station 318 that uses the same or similar precoder vector from being scheduled to receive a downlink data transmission during the same time-frequency interval as the k-th UT.

In another embodiment, the k-th UT served by base station 302 can decode DeModulating Reference Signals (DMRSs) transmitted by base station 302 for one or more other UTs served by base station 302. The k-th UT can decode these DMRSs to determine, for one or more of the other UTs, the channel between base station 302 and the k-th UT as precoded by base station 302 for a particular one of the other UTs served by base station 302. Knowledge of these effective channels, in conjunction with knowledge of the modulation schemes used by base station 302 to transmit downlink, can be used to decode, at the k-th UT, the downlink data signals sent to the other UTs by base station 302 during MU-MIMO transmission. Once the downlink data signals are decoded, the k-th can remove this interference from the received composite signal.

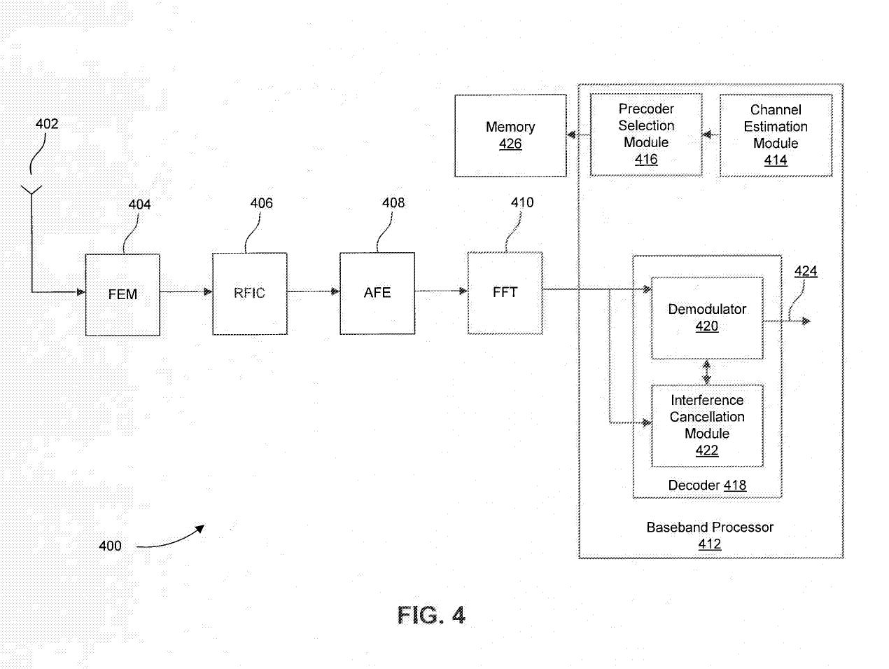

Referring now to FIG. 4, an example receiver 400 according to an embodiment is illustrated. Example receiver 400 is provided for the purpose of illustration only and is not limiting of embodiments. Example receiver 400 can be, for example, any of UT receivers 304-1 through 304-K in FIG. 3 and can be used to receive Orthogonal Frequency Division Multiplexing, (OFDM)-based signals.

As shown in FIG. 4, example receiver 400 includes a receive antenna 402, a front-end module (FEM) 404 (e.g., may include discrete components such as duplexers, switches, and filters), a radio frequency integrated circuit (RFIC) 406 (e.g., may include analog components such as mixers, low-pass filters, etc.), an analog front-end (AFE) 408 (e.g., may include mixed signal components such as digital-to-analog converters), a Fast Fourier Transform (FFT) module 410, and a baseband processor 412. Operation of FEM 404, RFIC 406, AFE 408, and FFT module 410 are well known in the art and are not described herein. The combination of one or more of FEM 404, RFIC 406, APE 408, and FFT module 410 can be simply referred to as the radio of example receiver 400.

Baseband processor 412 includes, among other components, a channel estimation module 414 and a precoder selection module 416. Channel estimation module 414 is configured to estimate the channel between receiver 400 and its serving base station and the channel between receiver 400 and an interfering base station. Channel estimation module 414 is configured to estimate these channels using reference signals aligned in time and frequency as discussed above. The output of FFT module 410 includes these reference signals and can be processed by channel estimation module 414 to provide the channel estimates to a precoder selection module 416.

In one embodiment, precoder selection module 416 is further included in baseband processor 412 and is configured to select precoders based on the channel estimates provided by channel estimation module 416. Precoder selection module 416 can determine a precoder, as described above in regard to FIG. 3, for the interfering base station that suppresses or minimizes interference from the interfering base station and can also determine a precoder for its serving base station that enhances the signal strength of a data stream sent to receiver 400 from its serving base station. In one embodiment, precoder selection module 416 selects the precoders from one or more codebooks and each selected precoder corresponds to a respective precoding matrix index (PMI) in the one or more codebooks. The codebooks can be pre-stored in memory 426. Once determined, receiver 400 can feedback the determined precoders or PMI indices to its serving base station to allow coordination between the serving base station and the interfering base station as described above in regard to FIG. 3.

Baseband processor 412 can further include, among other components, a decoder 418, which includes a demodulator 420 and an interference cancellation module 422. In another embodiment (not shown in FIG. 4), demodulator 420 and interference cancellation module 422 are combined in a single module, which performs the functions of both demodulator 420 and module 422. Demodulator 420 is configured to generate a data bit stream 424 based on the output of FFT module 410. Typically, the output of FFT module 410 includes a composite signal of a desired information signal and interference. Data bit stream 424 is representative of an estimate of the desired information signal. Demodulator 420 can be aided by interference cancellation module 422 to enhance data bit stream 424 by reducing or eliminating the interference in the composite signal used by demodulator 420 to generate data bit stream 424.

Interference cancellation module 424 is configured to estimate the interference in the output of FFT module 410 and to provide the estimated interference to demodulator 420. Demodulator 420 uses the estimated interference from module 422 to enhance the decoding performance of data bit stream 424. In an embodiment, interference cancellation module 422 is configured to decode the interference (e.g., generate a symbol stream representative of the interference) and to provide the decoded interference to demodulator 420. Demodulator 420 subtracts the decoded interference from the composite signal to generate data bit stream 424. The interference can come from other UTs served by the base station of receiver 400 as explained above in regard to FIG. 3. More specifically, the interference can come from other UTs that receive downlink transmissions during the same time-frequency interval as receiver 400 from the serving base station operating in a MU-MIMO mode.

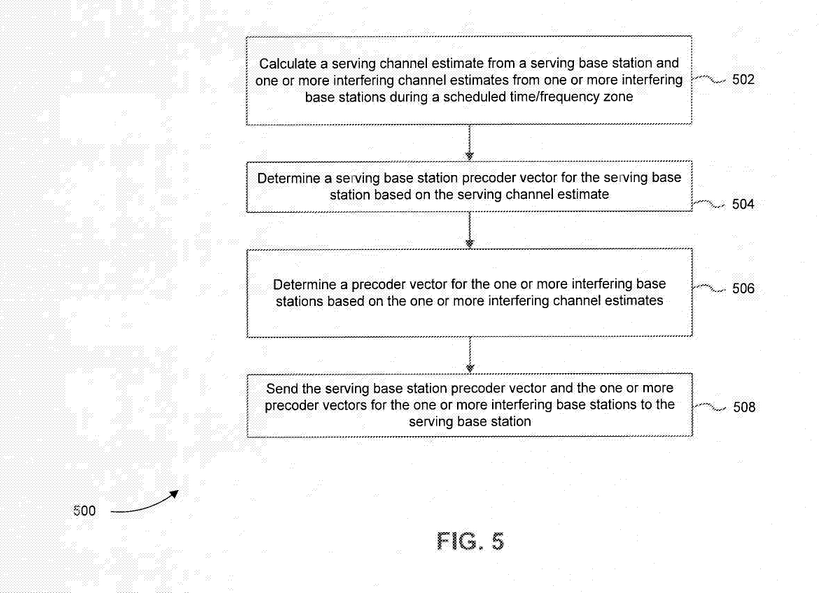

FIG. 5 is an example process 500 for facilitating interference alignment and suppression according to an embodiment. Example process 500 is provided for the purpose of illustration only and is not limiting. Example process 500 can be performed by a UT, such as a UT that includes one of the UT receivers 304-1 through 304-K in FIG. 3.

As shown in FIG. 5, example process 500 begins in step 502, which includes calculating a serving channel estimate from a serving base station and one or more interfering channel estimates from one or more interfering base stations during a scheduled time/frequency zone. As understood by a person of skill in the art based on the teachings herein, embodiments are not limited to use within a scheduled time/frequency zone but can be extended generally to any other time/frequency period. In an embodiment, calculation of the channel estimates in step 502 is enabled by virtue of the base stations aligning their respective non-zero power and zero power reference signals during the scheduled time/frequency zone as described above with respect FIG. 2.

Subsequently, process 500 proceeds to step 504 which includes determining a serving base station precoder vector or possible vectors for the serving base station based on the serving charnel estimate. In an embodiment, step 504 further includes calculating the serving base station precoder vector or possible vectors to increase above a threshold or maximize a signal strength and/or data throughput from the serving base station to the UT.

Then, in step 506, process 500 includes determining one or more precoder vectors for the one or more interfering base stations based on the one or more interfering channel estimates. In an embodiment, step 506 further includes calculating the one or more precoder vectors such that the precoder vector multiplied by the interfering channel estimate is minimized or reduced, for example, below some threshold. In other words, step 506 includes calculating the one or more precoder vectors to reduce the energy received from the one or more interfering base stations.

Finally, process 500 terminates in step 508, which includes sending the serving base station precoder vector and the one or more precoder vectors for the one or more interfering base station to the serving base station. The serving base station and the one or more interfering base stations can then coordinate as described above based on these fed back precoder vectors to reduce or minimize interference during MU-MIMO downlink transmission. It should be noted that, in other embodiments, a PMI can be feedback to the serving base station for one or more of the calculated precoder vectors as opposed to the actual precoder vectors.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, lased on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

What is claimed is:

1. A method for suppressing interference at a user terminal during multi-user multiple-input multiple-output (MU-MIMO) downlink transmission, comprising:
calculating a serving channel estimate from a serving base station and one or more interfering channel estimates from one or more interfering base stations during a scheduled time and frequency (time/frequency) zone;
determining a serving base station precoder vector for the serving base station based on the serving channel estimate; and
determining one or more precoder vectors for the one or more interfering base stations based on the one or more interfering channel estimates to reduce interference received by the user terminal from the one or more interfering base stations.

2. The method of claim 1, wherein the calculating comprises calculating the serving channel estimate and the one or more interfering channel estimates from time and frequency aligned respective reference signals of the serving base station and the one or more interfering base stations during the scheduled time/frequency zone.

3. The method of claim 1, wherein the respective reference signals include at least a non-zero power reference signal of the serving base station and zero power reference signals of the one or more interfering base stations.

4. The method of claim 1, wherein determining the serving base station precoder vector comprises calculating the serving base station precoder vector to increase a data throughput from the serving base station to the user terminal.

5. The method of claim 1, wherein determining the one or more precoder vectors for the one or more interfering base stations comprises calculating the one or more precoder vectors for the one or more interfering base stations to reduce an energy of one or more interfering signals from the one or more interfering base stations at the user terminal.

6. The method of claim 1, further comprising sending the serving base station precoder vector to the serving base station.

7. The method of claim 1, further comprising sending one or more precoder vectors for the one or more interfering base stations to the serving base station.

8. A method for suppressing interference during multi-user multiple-input multiple-output (MU-MIMO) downlink transmission, comprising:
receiving, from a user terminal served by a serving base station, precoder information for the serving base station and precoder information for an interfering base station; and
based on the precoder information for the serving base station and the precoder information for the interfering base station, coordinating with the interfering base station to schedule a user terminal served by the interfering base station with the user terminal served by the serving base station for downlink transmission during a same time-frequency interval.

9. The method of claim 8, wherein a downlink data stream transmission to the user terminal served by the serving base station during the time-frequency interval is precoded using the precoder information for the serving base station.

10. The method of claim 9, wherein a downlink data stream transmission to the user terminal served by the interfering base station during the time-frequency interval is precoded using the precoder information for the interfering base station.

11. The method of claim 8, further comprising:
signaling a scheduled time and frequency (time/frequency) zone to the user terminal served by the serving base station; and
aligning in time and frequency at least a first reference signal of the serving base station with a second reference signal of the interfering base station during the scheduled time/frequency zone.

12. The method of claim 8, wherein the aligning comprises aligning in time and frequency a non-zero power reference signal of the serving base station with a zero power reference signal of the interfering base station during the scheduled time/frequency zone.

13. The method of claim 12, wherein the aligning further comprises aligning in time and frequency a zero power reference signal of the serving base station with a non-zero power reference signal of the interfering base station during the scheduled time/frequency zone.

14. The method of claim 8, wherein the precoding information for the serving base station comprises a precoding matrix index (PMI).

15. An apparatus for suppressing interference at a user terminal during multi-user multiple-input multiple-output (MU-MIMO) downlink transmission. comprising:
a radio configured to process a signal received during a scheduled time and frequency (time/frequency) zone; and
a baseband processor configured to:
calculate a serving channel estimate from a serving base station and one or more interfering channel estimates from one or more interfering base stations using the signal;
determine a serving base station precoder vector for the serving base station based on the serving channel estimate;
determine one or, more precoder vectors for the one or more interfering base stations based on the one or more interfering channel estimates to reduce interference received by the user terminal from the one or more interfering base stations; and
send the serving, base station precoder vector to the serving base station and the one or more precoder vectors for the one o ore interfering base stations to the serving base station.

16. The apparatus of claim 15 wherein the calculating comprises calculating the serving channel estimate and the one or more interfering channel estimates from time and frequency aligned respective reference signals of the serving base station and the one or more interfering base stations during the scheduled time/frequency zone.

17. The apparatus of claim 15, wherein the respective reference signals include at least a non-zero power reference signal of the serving base station and zero power reference signals of the one or more interfering base stations.

18. The apparatus of claim 15, wherein determining the serving base station precoder vector comprises calculating the serving base station precoder vector to increase a data throughput from the serving base station to the user terminal.

19. The apparatus of claim 15, wherein determining the one or more precoder vectors for the one or more interfering base stations comprises calculating the one or more precoder vectors for the one or more interfering base stations to reduce an energy of one or more interfering signals from the one or more interfering base stations at the user terminal.

20. The method of claim 15, wherein the baseband processor is further configured to send the serving base station precoder vector to the serving base station.
